(19) United States
(12) Patent Application Publication
(10) Pub. No.: US 2004/0018345 A1
(43) Pub. Date: Jan. 29, 2004

(54) Dry-erase ink marking media

(76) Inventors: Yvonne K. Athorn-Telep, Florence, MA (US); David A. Telep, Florence, MA (US)

Correspondence Address: Mark Levy, SALZMAN & LEVY, Ste.902, 19 Chenango Street, Binghamton, NY, 13901, US

(21) Appl. No.: 10/205,329

(22) Filed: Jul. 26, 2002

(51) Int. Cl. B32B 3/00

(52) U.S. Cl. 428/195.1

(57) ABSTRACT

The present invention relates to an article and its manufacture for use as a dry erase media. In particular, the invention provides for an article that has permanent and transient indicia or artwork. The transient indicia or artwork is applied to a topmost surface of a substrate using dry erase inks, and the permanent indicia or artwork is applied to the lowermost surface of the substrate. The substrate itself is transparent or translucent to allow both transient and permanent indicia or artwork to be viewed simultaneously as a single apparent image that is informationally interactive.

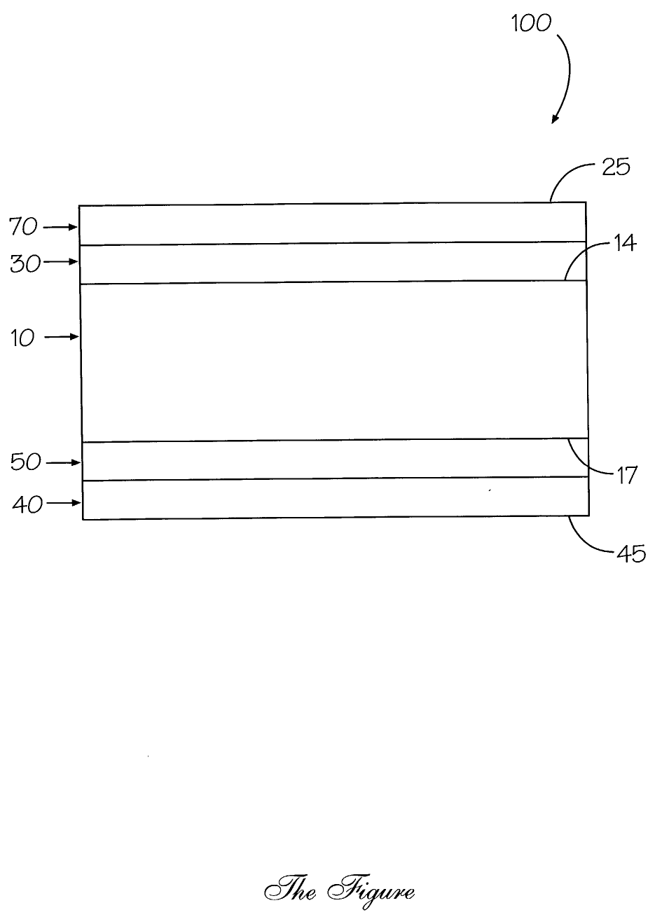

### FIELD OF THE INVENTION

The present invention relates to a dry erase media and, more particularly, to an article and its manufacture for use as a dry erase media that has permanent and transient indicia or artwork.

### BACKGROUND OF THE INVENTION

Prior art designs for whiteboards utilize uncoated polymeric films such as polyvinyl chloride. These materials typically have not performed well with regard to deterioration and stain. Products utilizing this design tend to capture only the “low end” portion of the market; for example, disposable, or single or limited reuse applications. Advancements to the art have included applying an “inert” layer to a polymeric substrate. This “inert” layer was designed to have superior properties like low solvent absorption, physical durability, glossy appearance, etc. For example, polypropylene film-surfaced, erasably markable articles have been used commercially but even these have been shown to gradually deteriorate with repeated application and erasure of dry wipe inks. Polyfluoropolymers have been used as a replacement for polypropylene to improve the deterioration problem but these materials are difficult to apply as a coating onto polymeric substrates and are very expensive; typically, coating waste is unacceptably high. Other overcoating formulations like heat-curable, e-beam, or UV radiation-curable lacquers have been used. For example, acrylate resins have been used in this application.

### DISCUSSION OF RELATED ART

In U.S. Pat. No. 5,721,309, issued to Sharma et al on Feb. 24, 1988 for AQUEOUS COATING FOR VINYL CHLORINE POLYMER SUBSTRATE, a useful first coating layer formulation is described. An aqueous based coating composition is described comprising a cross-linkable acrylate latex, an amino resin cross-linking agent, and a cross-linking catalyst for use in producing a stain-resistant coating for polyvinyl chloride polymer substrates and are hereby incorporated by reference.

A number of different fluorocarbon polymers are known that will form writable/dry wipeable surfaces. Examples include polymers and co-polymers containing one or more polymerized monomers selected from the group consisting of: tetrafluorethylene (TFE); chlorotrifluoroethylene (CTFE); vinyl fluoride (VF); vinylidene fluoride (VDF); and hexafluoropropylene (HFP). Preferred polymers and co-polymers are those containing at least 50% by weight TFE, CTFE, VF, VDF, HFP, or mixtures thereof. Preferred polymers are polyethylene/tetrafluoroethylene (poly ETFE), polyethylene/chlorotrifluoroethylene (poly ECTFE), polytetrafluoroethylene (poly TFE), poly-vinyl fluoride (poly-VF) and poly-vinylidene fluoride (poly-VDF).

Especially preferred polymers are co-polymers containing at least 50% by weight VDF, especially VDF/HFP copolymers. An especially preferred polymer is sold by Elf-Autochem North America Inc. of King of Prussia, Pa. under the designation of Kynar 2800. Other examples of suitable writable/dry wipeable fluorocarbon polymers are disclosed in U.S. Pat. No. 6,251,500, issued to Varga et al on Jun. 26, 2001 for WRITE-ON/WIPE OFF WALL COVERING; U.S. Pat. No. 4,746,576, issued to Ozu et al on May 24, 1988 for WRITING SCREEN; and U.S. Pat. No. 3,922,457, issued to Barnwell et al on Nov. 25, 1975 for DRY WIPE WRITING SYSTEM AND INK THEREFOR, all hereby incorporated by reference.

Particular commercially available polymers useful in forming a protective covering are: ACLAR (available from Allied Signal Corp. and believed to be a chlorotrifluoroethylene copolymer); KORTON-K 720 (available from Norton/Allied and believed to be a polyvinylidene chloride polymer); and KYNAR 730 (2800 (available from Autochem North America and believed to be a polyvinylidene chloride homopolymer).

Examples of useful cured epoxy first coating layer formulations are described in U.S. Pat. No. 6,265,074, issued to Shah et al on Jul. 24, 2001 for WRITE-ERASE BOARD, which is hereby incorporated by reference in its entirety.

Other useful first coating layer formulations are described in U.S. Pat. No. 4,988,123, issued to Lin et al on Jan. 29, 1991 for ERASABLE SYSTEM INCLUDING MARKING SURFACE AND ERASABLE INK COMPOSITION, which is hereby incorporated by reference.

United States Patent Application No. 20010024720, filed on Sep. 27, 2001 for DRY ERASE MEMBER by Sweet et al describes a dry erase formulation comprising either fluoroethylene alkyl vinyl ether copolymers or cellulose acetate propionate in combination with a modified melamine-formaldehyde resin and an organic sulfonic acid. Such formulations do not require a radiation-curing step. Furthermore, this formulation allows the ability to image by xerographic copier or laser printer. Such formulations are within the scope of the present invention for use as a first coating layer and United States Patent Application No. 20010024720 is hereby incorporated by reference in its entirety.

### SUMMARY OF THE INVENTION

In accordance with the present invention, there is provided an erasably markable article formed of a coated substrate having a first major lateral surface that is markable with dry wipe inks. The surface after marking is substantially fully erasable and does not cause permanent discernible distortion of the substrate. The first surface is provided by a uniform coating of cured lacquer, preferably a radiation-cured lacquer; for example, a lacquer of acrylate monomers cured by UV irradiation.

The second major lateral surface of the article consists of a coating layer to which areas containing indicia or artwork are applied in a wrong-reading modality. The indicia can be applied via: ink jet; electrophotographic or conventional printing; or manually. The substrate itself and its coating layers can be, optically transparent, semitransparent, or transparent to a portion of the electromagnetic spectrum outside the visible region. Viewed through the first major surface, the indicia or artwork affixed to the second major lateral surface appears right-reading and, in conjunction with the applied dry wipe inks, form what appears to be an integral display.

One benefit of the present invention is that the artwork or indicia applied to the second major lateral surface is protected from the elements by the substrate and the first surface. This is highly desirable to protect against fading due to incidental light. In a preferred embodiment either the first surface or the substrate contains a filter material to reduce the level of ultraviolet light from impinging on the indicia or artwork.

Another benefit of the present invention is the ability to apply both the first surface coating and the second surface coating in a single pass through a coating machine.

Yet another benefit to the user of the present invention is the integration of the image receiver and the dry erase functionality saving fabrication time, effort, and money.

Still another benefit of the present invention is to use the article in security applications where the artwork or indicia is not visible to the naked eye due to using an optically opaque substrate, yet under impingement by wavelengths of radiation to which the substrate is transparent, the artwork or indicia is observable. In particular in this application it is preferred that the substrate be transparent in the infrared region of the spectra but opaque in the visible region.

At least some of these hereinabove mentioned benefits will be obtained in any given embodiment of the present invention.

### BRIEF DESCRIPTION OF THE DRAWINGS

A complete understanding of the present invention may be obtained by reference to the accompanying drawing, when considered in conjunction with the subsequent detailed description, in which:

The FIGURE is a cross-section of an exemplary rendition of a dry-erase article of the present invention.

### DESCRIPTION OF THE PREFERRED EMBODIMENT

Having described in general terms the present invention, greater detail will be presented for each of the elements comprising the dry erasable article 100 of the present invention and suitable processes to manufacture this article 100, shown in the FIGURE.

The substrate in the present invention is preferably comprised of a flexible polymeric material. The thickness of the substrate can be within a wide range and is dictated by the type of coating machinery, the chemical composition of the substrate, and the ultimate use of the dry erase article 100. Typically, thicknesses of approximately 0.5 to 15 mil are useful in the present invention. Preferred thicknesses range from 1 to 10 mil, with most ranging between 2 and 8 mil.

The substrate 10 must allow adhesion of a first coating layer 20 to the uppermost lateral surface 14 of the substrate 10, as shown in the FIGURE. This first coating 20 can be applied directly to the uppermost lateral surface 14 or optionally to a first subbing layer 30 applied between the uppermost lateral surface 14 and the first coating layer 20. Likewise, the substrate 10 must allow adhesion of a second coating layer 40 to the lowermost lateral surface 17 of the substrate 10. This second coating 40 can be applied directly to the lowermost lateral surface 17 or optionally to a first subbing layer 50 applied between the lowermost lateral surface 17 and the second coating layer 40.

Most common film forming polymeric materials can be used in the present invention. Materials like cellulosics (such as cellulose acetate, ethyl cellulose, cellulose acetate butyrate, cellulose propionate and cellulose triacetate); polycarbonates, polyesters, polyurethanes, polyolefins (such as polyethylene or polypropylene, including biaxial oriented polypropylene (BOPP)); halopolymers, acrylates, styrenic polymers, polyamides, vinyl polymers (such as polyvinyl acetate) and combinations thereof, are useful in the present invention. These materials may be homopolymeric or copolymeric. Most preferred are film-forming polyesters. These polyesters can be derived from reactions of diols and dicarboxylic acids or esters.

Preferred diols include ethylene glycol, propylene glycol, 1,3-propanediol, 1,4-butanediol, 1,3-butanediol, 2,3-butanediol, and the isomers of hexanediol. Preferred dicarboxylic acids include aliphatic dicarboxylic acids such as butanedioic acid or hexanedioic acid and aromatic dicarboxylic acids like terephthalic or the isomers of napthylenedioic acid. The preferred esters include the lower alkyl or hydroxyalkyl esters of the above named diacids. In particular, preferred polyesters are polydimethyleneterephthalate (also known in the industry as polyethyleneterephthalate (PET)); polytrimethylene terephthalate; polytetramethyleneterephthalate; and polydimethylenenaphthalenedioate.

The film substrate can be colored or uncolored and can be essentially transparent or translucent due to the addition of fillers, colorants, surface modifications (e.g., metalizing), or matting agent. In the preferred embodiment the substrate is transparent.

Again referring to the FIGURE, the uppermost 14 and lowermost 17 surfaces of the substrate 10 can be corona treated or otherwise exposed to an electrical discharge to increase adhesion of the coated layers 20 and 40. The corona treatment can be performed in-line prior to application of the coating layers 20 and 40 or in a prior separate step. Most preferred is in-line application of the corona treatment.

The first coating layer 20 is applied over an intermediary, optional subbing layer 30 to the uppermost surface 14 of the substrate 10. The application of the first coating layer 20 can be performed by techniques such as cascade coating, dip coating, extrusion coating, wire bar coating, air knife coating, gravure coating, forward and reverse roll coating, die coating, spraying, doctoring, brushing, meniscus coating, and other well known techniques. Some critical features of the coating must be a final, dry, uniformly exposed major lateral surface 25. It is this exposed surface 25 onto which the dry erase ink will later be applied.

The composition of this first coating layer 20 can be selected from a diverse population of film forming resins or elastomeric polymers; however, they must be functionally able to accept dry erase inks to provide acceptable optical densities and must then provide easy removal with essentially no residual image or optical density (i.e., no stain). Useful compositions include fluoropolymers, polysiloxanes, cured epoxy, and lacquers (preferably a radiation-cured lacquer); for example, UV-cured acrylate monomer lacquers and electron beam radiation-cured urethane acrylate.

A dry erase surface coating comprising a first coating layer 20 overcoating a substrate 10 is supplied by Craigcoat as CRAIGCOAT 1077Q. In a preferred formulation, the first coating layer 20 comprises a UV-cured WHITEBOARD coating formulation supplied by InteliCoat Technologies, formerly Rexam Image Products, located in South Hadley, Mass., USA. This formulation will not yellow over time under normal conditions including exposure to sunlight. The radiation-curable resins useful in the present invention are disclosed in U.S. Pat. No. 5,037,702, issued to Pitts et al on Aug. 6, 1991 for ERASABLY, MARKABLE ARTICLES AND METHODS OF MAKING SUCH ARTICLES, hereby incorporated by reference in its entirety.

First coating layer 20 may contain additional ingredients like fillers, surfactants, adhesion promoters, lubricants, matting agents, slip additives, nucleating agents, plasticizers, reinforcing agents, antiblocking agents, oxidation stabilizers, thermal stabilizers, and ultraviolet light stabilizers.

The gloss of the article 100 can be modified according to aesthetics. Sometimes surfaces that are too glossy are less preferred and the addition of suitable, non-staining matting agents having a particle size ranging from about 1 to 10 microns effectively lowers the gloss. However, it is expressly within the scope of the present invention that all levels of gloss are potentially useable, limited only by their ability to provide a stain-free dry-erase surface.

In a preferred design, the first coating layer 20 is applied as an overcoat via gravure, flexo, roller, or blanket coaters. No post-curing or aging of the coating is required.

The thin, clear-coated functional layer provides the dual benefits of a hardcoat yet is sufficiently flexible to allow the article 100 to be bent up to 180 degrees without cracking. The first coating layer 20 is approximately 1 to 10 microns, preferably 1 to approximately 8 microns, and most preferably approximately 2 to 6 microns. The material will survive conventional graphic arts laminating steps and has passed through commercial embossing equipment (2200 F, 2000 psi, 8 fpm) with no loss in functionality.

The composition of the first coating layer 20 is designed to allow dry erase inks to be applied and readily removed with minimal effort. It is most preferable that the first coating layer 20 be non-porous with regard to the solvent formulation used in the dry-erasable markers. Many dry ink formulations are commercially available and the present invention has been designed to work with essentially all such formulations. For example, useful dry erase ink formulations like Sanford “Expo,” Sanford “Expo2,” and Avery “Marks-A-Lot” are amenable with the present inventive first coating layer. In particular, excellent compatibility has been observed with Expo brand markers. Marker ink should readily spread onto the writing surface without beading.

Erasure should be essentially effortless using a fingertip, light rag, or eraser, even with imaging that has remained on the surface for months. It is important to note that removal of the image should leave essentially no residual stain. Furthermore, in the event of inadvertent application of a permanent ink pen like a Sharpie® pen to the surface of the first coating layer 20, removal of the image can be achieved by overwriting with a correct dry ink pen and then erasing. Images due to permanent inks can still be removed after several days unlike previous articles. Removal can be accomplished by using dry erasing, a dry wipe eraser, paper tissue, cloth, or some other appropriate material.

Dry erase pen chemistries differ from brand to brand as well as between colors within brands. Given the differences, certain colors are more susceptible to inducing stains on standard prior art whiteboards. A critical feature of the present invention is that the first coating layer 20, otherwise referred to as the frontside coating must be essentially impervious to the solvents that are used in the dry ink formulations.

If solvent should permeate below the surface of layer 20 and thereby absorb beneath the surface then a permanent stain or “ghost image”, will occur in the imaged areas. This is highly undesirable but exhaustive testing has shown that the present invention is essentially free of such stain. The inventive design has been tested for stainability using a broad spectrum of pen colors and manufacturers. Exposing the inventive first coating layer 20 after application of dry erase inks from a battery of test colors throughout the spectrum to harsh environmental testing conditions of 122° F./95% RH for 2 weeks produced no detectable stain.

The first coating layer 20 can also be cleaned with commercial white board cleaners. The preferred surface will withstand prolonged cleaning cycles with cleaner formulations comprising isopropyl alcohol, methyl ethyl ketone, acetone, ammonia, and gasoline with no loss in write/erase performance.

The second coating layer 40 is applied over an intermediary, optional subbing layer 50 to the uppermost surface 17 of the substrate 10. The application of the second coating layer 40 can be performed by such techniques as cascade coating, dip coating, extrusion coating, wire bar coating, and other well known techniques as previously described for the first coating layer 20. The outermost surface 45 away from the substrate surface 17 can be either smooth or roughened by matte depending on the final imaging technique and ultimate visual preference. For example, if a hazy appearance for the finished article 100 is desired, then the second coating layer 40 can comprise a heavily matted composition. Critical to the success of the present invention is to design the second coating layer 40 to receive an image. The image can be generated by manual or mechanical means but typically standard printing applications such as rotogravure, flexography, offset, silk screen, and UV cure printing are used to apply the inked image. Also, digitized imaging can be achieved through the use of ink jet or bubble jet printing inks or xerographic or laser electrophotographic toners. Although it would be ideal to have a single second coating formulation for all imaging modalities, the present invention typically utilizes highly optimized formulations for one or more specific modalities.

One preferred product of the present invention utilizes a coated substrate supplied by Hanita Coatings, Kibbutz Hanita, Ill. In this manner the coated substrates comprise the substrate 10 and the second coating layer 40. Coated preferred substrates are optimized to receive either ink jet inks and/or electrophotograghic toners. For example, K0501X, K10005, K05032, and K10030 have all been designed to specifically receive ink jet inks, while K05021, K10002, K05020, and K10001 have been designed to receive both ink jet inks and electrophotographic toners.

The Hanita DURA-GO products have been optimized to accept INDIGO inks while the DURAKOTE products accept dry toner for electro-photo digital presses and have been optimized for XEIKON engines used by XEIKON, AGFA, IBM, and XEROX copiers. Hanita K05032 was optimized for laser toner printing. The Hanita coatings have been tested in ink jet printers like HP LASERJET 1200C, 850C, 720C, 660C, 690C, 695C, 560C; HP DESIGNJET 200CP; and COLORSPAN LASERMASTER; and in Canon BJC 600, Epson 1520, HP LASERJET 5, and HP LASER 4SI. Other combinations of materials comprising a single second coating layer 40 overcoating a substrate 10 are Tektronix Phaser 560 and 740 Transparencies (which accept color laser toner printing) and Xerox Phaser 7700 transparencies designed for oil-less fuser printer technology. InteliCoat Technologies, formerly Rexam Image Products, DMBP5 and DMBPC12 accept ink jet inks, Tektronix Phaser 850 Transparencies are designed to accept ink jet solid inks, and Epson LTR Transparencies are designed to accept ink jet inks.

As previously mentioned, the second coating layer 40 can also be imaged by conventional printing as compared to the above-mentioned digital printing. Useful composites comprising a second coating layer 40 overcoating a substrate 10 are commercially available from Hanita Coatings supplied as K02301/2, designed to accept a wide range of printing inks used in rotogravure, flexography, offset, silk screen, and UV cure printing processes; HP Transparency Plotter Film 17702T; and Hanita Coating K03604E, designed to accept thermal transfer, high speed computer printers, typewriters, markers, and ballpoint pens.

The second coating layer 40, also known in the art as a primer layer, can also comprise a two component polyurethane type that is clear and non-blocking. Such a material is supplied by Hanita Coatings, located in Kibbutz Hanita 22885 Israel.

In one preferred embodiment both first 20 and second 40 coating layers are applied in a single pass to opposite sides of the substrate 10 as it passes through a coating machine.

A significant benefit of the current invention is that the application of the first 20 and second 40 coating layers to the substrate 10 are achieved without the need for lamination and can be obtained in a single coating pass thereby saving significant expense and potential yield loss due to problems associated with the laminating process (e.g., creasing, contamination, etc.). Although coating using liquid formulations is preferred for application of the layers 20 and 40 respectively, lamination of either is still feasible and within the scope of the present invention.

Depending on the application needs (e.g., aesthetics, zonal functionality, machine readability, light diffusion, etc.), each of the three main parts of the invention (the dry-erase first coating layer 20, the substrate 10, and the image receptive second coating layer 40) may be independently clear, semi-transparent, opaque, translucent, or fluorescent. Further, these characteristics can be varied across the major planes of these three main parts.

Highly preferred products of the present invention comprise:

Design 1:

InteliCoat Technologies, formerly Rexam Image Products,

Whiteboard Film coating (first coating layer 20)

polyester substrate (substrate 10)

Hanita DURA-GO (second coating layer 40)

Design 2:

InteliCoat Technologies, formerly Rexam Image Products, Whiteboard Film coating (first coating layer 20)

polycarbonate substrate (substrate 10)

Hanita DURA-GO (second coating layer 40)

Design 3:

InteliCoat Technologies, formerly Rexam Image Products,

Whiteboard Film coating (first coating layer 20)

polyester substrate (substrate 10)

Hanita DURAKOTE (second coating layer 40)

Design 4:

InteliCoat Technologies, formerly Rexam Image Products, Whiteboard Film coating (first coating layer 20)

polyester substrate (substrate 10)

Rexam DMBP5 (second coating substrate 40).

After application of the first 20 and second 40 coating layers, the in-process article 100 can now be imaged on the second coating layer 40 opposing surface 17. The image can be a graphic design like artwork, or indicia like alphanumeric symbols, or combinations thereof. In one embodiment the artwork comprises a border image while in other embodiments the image is within the central region of the article 100. The image can be either monotone or multicolored and can be applied in a single or multiple-pass imaging process.

Optionally, the imaged article 100 can be used directly (i.e., the backside imaged substrate can be used to receive dry erase inks on its front side surface), or the backside-imaged substrate can be laminated to different supports. These supports are affixed to the imaged backside and can be used to provide rigidity or a means to affix the aggregate unit to an external feature. For example, the support may comprise a magnetic backing that would allow the article 100 to be affixed to a metallic surface. Likewise the support may comprise a two-sided adhesive, thereby allowing the article 100 to be affixed to essentially any planar surface. Whether a support is optionally used or not, the substrate and the coated layers 20 and 40 comprising the article 100 may be in either a planar or bent configuration prior to and after the imaging by the dry inking application. For example, the article 100 can be wrapped around a cylindrical core with the first coating layer 20 exposed so as to be available to be written on.

The dry ink application using a pen or marker can allow for the dry-inked image to have sufficient adhesiveness so as not to smear or inadvertently be erased, yet if desired can be erased without undue hardship. In one embodiment the erasure is facilitated by use of an organic or water solvent. If a solvent is employed for ecological reasons it is highly preferred that the solvent be water based. For example, Expo dry erase pens rub off without the need for solvent, while dry erase pens such as Crayola “Color Wipeoffs” or Day-Runner “Wipe-Out” may require the use of water to completely remove images on the first coating layer 20. Erasure can be facilitated with either an elastomeric eraser or towel made of cloth or paper tissue.

In one embodiment of the invention the dry ink is water resistant to allow use of the present invention in outdoor locations under wet conditions.

All colors of inks can be applied either simultaneously or sequentially. Even multiple coats of dry ink image can be readily removed from the first coating layer 20 of the current invention.

In a preferred embodiment the graphic image applied to the second coating layer 40 should be informationally interactive with the dry ink application on the first coating layer. For example, if the backside image to the second coating layer 40 comprises a series of headings and corresponding cells, the user is essentially directed to fill in information within the given cells corresponding to the information in the headings. In this manner there is a direct informational link between the permanent information on the backside and the transient information on the frontside dry ink application. For example, a restaurant menu might comprise a fixed fare that would be printed on the backside, but periodic changes to the daily special or pricing can be made to the front side and changed on an as needed basis.

Other applications include maps for the purpose of giving directions that are erasable, engineering draft drawings, advertising information, calendars having daily reminders, weather maps, medical charts, board games, labels, etc.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of the invention.

Having thus described the invention, what is desired to be protected by Letters Patent is presented in the subsequently appended claims.

What is claimed is:

1. A dry-erasable article comprising:
a) a substrate comprising an upper and a lower major lateral surface,
b) a first coating layer affixed to said upper major lateral surface, said first coating layer comprising a dry-erase ink receiving surface; and
c) a second coating layer affixed to said lower major lateral surface, said second coating layer comprising an image-receiving surface.

2. The dry-erasable article as recited in claim 1, wherein said substrate comprises a flexible or rigid polymer.

3. The dry-erasable article as recited in claim 2, wherein said polymer comprises celluloses, polycarbonates, polyesters, polyurethanes, polyolefins, halo polymers, acrylates, styrene polymers, polyamides, vinyl polymers and combinations thereof.

4. The dry-erasable article as recited in claim 2, wherein said polymer is optically transparent or translucent.

5. The dry-erasable article as recited in claim 1, wherein said first coating layer comprises a film-forming resin allowing essentially stain-free removal of dry-erasable images from said dry-erase ink receiving surface.

6. The dry-erasable article as recited in claim 1, wherein said first coating layer comprises a film-forming resin allowing essentially stain-free removal of dry-erasable images from said dry-erase ink receiving surface after application of a dry-erase ink and conditioning at 122° F. and 95% RH for 2 weeks.

7. The dry-erasable article as recited in claim 1, wherein said first coating layer comprises fluoropolymers and lacquers.

8. The dry-erasable article as recited in claim 7, wherein said lacquer comprises a radiation-cured lacquer.

9. The dry-erasable article as recited in claim 8, wherein said radiation-cured lacquer comprises UV-cured acrylate monomer lacquers and electron beam radiation-cured urethane acrylates.

10. The dry-erasable article as recited in claim 1, wherein said second coating layer comprises resins capable of affixing and essentially permanently adhering ink jet images.

11. The dry-erasable article as recited in claim 1, wherein said second coating layer comprises resins capable of affixing and essentially permanently adhering electrophotographic images.

12. The dry-erasable article as recited in claim 1, wherein said second coating layer comprises resins capable of affixing and essentially permanently adhering conventionally printed images.

13. The dry-erasable article as recited in claim 1, wherein said substrate comprises polyester, said first coating layer comprises InteliCoat Technologies, formerly Rexam IMAGE PRODUCTS, WHITEBOARD FILM COATING, and said second coating layer comprises materials selected from the group consisting of Hanita DURA-GO, Hanita DURAKOTE and Rexam DMBP5.

14. The dry-erasable article as recited in claim 1, wherein said substrate comprises polycarbonate, said first coating layer comprises InteliCoat Technologies, formerly Rexam IMAGE PRODUCTS, WHITEBOARD FILM COATING, and said second coating layer comprises Hanita DURA-GO.

15. The process of making a dry-erasable article comprising the steps of:
a) providing a composite material comprising a substrate comprising an upper major lateral surface and a lower major lateral surface and an image receiving layer affixed to said lower major lateral surface; and
b) applying a dry-erase ink receiving layer to said upper major lateral surface.

16. The process of making a dry-erasable article comprising the steps of:
a) providing a substrate comprising upper and lower lateral surfaces;
b) applying a dry-erase ink receiving layer to said upper major lateral surface; and
c) applying an image receiving layer to said lower major lateral surface.

17. The process as recited in claim 16, wherein said steps (b) and (c) are reversed.

18. The process as recited in claim 16, wherein said steps (b) and (c) are performed in a single coating pass.

19. The process as recited in claim 17, wherein said steps (b) and (c) are performed in a single coating pass.
